(19) United States
(12) Patent Application Publication
(10) Pub. No.: US 2023/0305098 A1
(43) Pub. Date: Sep. 28, 2023

(54) DETERMINATION DEVICE, DETERMINATION METHOD, AND DETERMINATION SYSTEM

(71) Applicant: KABUSHIKI KAISHA TOKAI RIKA DENKI SEISAKUSHO, Aichi (JP)

(72) Inventors: Kazuki NAIKI, Aichi (JP); Tadashi FUKAGAI, Aichi (JP); Masateru FURUTA, Aichi (JP); Yuki KONO, Aichi (JP); Keigo KAGIMOTO, Aichi (JP)

(73) Assignee: KABUSHIKI KAISHA TOKAI RIKA DENKI SEISAKUSHO, Aichi (JP)

(21) Appl. No.: 18/089,667

(22) Filed: Dec. 28, 2022

(30) Foreign Application Priority Data
Mar. 25, 2022 (JP) 2022-049679

(51) Int. Cl. G01S 5/02; H04W 64/00; H04B 17/327

(52) U.S. Cl. CPC G01S 5/0284; H04W 64/003; H04B 17/327

(57) ABSTRACT

A determination device comprising a determination section configured to determine whether a portable device is positioned in a first area or a second area on a basis of results of ranging based on wireless communication between at least two first wireless communication devices and a second wireless communication device, the at least two first wireless communication devices being disposed with a boundary arrangement interposed therebetween, the boundary arrangement being arranged at a boundary between the first area and the second area, the second wireless communication device being installed in the portable device, wherein the determination section determines whether the portable device is positioned in the first area or the second area on a basis of a difference between ranging value calculated by first wireless communication device disposed in the first area and ranging value calculated by first wireless communication device disposed in the second area.

### CROSS REFERENCE TO RELATED APPLICATION(S)

This application is based upon and claims benefit of priority from Japanese Patent Application No. 2022-049679, filed on Mar. 25, 2022, the entire contents of which are incorporated herein by reference.

### BACKGROUND

The present invention relates to a determination device, a determination method, and a determination system.

In recent years, technologies of automatically unlocking a door or other locks have been developed. For example, JP 2018-98553A discloses a technology of transmitting information for opening a lock from a communication device carried by a user.

### SUMMARY

According to the technology disclosed in JP 2018-98553A, the door is unlocked when verification based on the information transmitted from the communication device succeeds. However, the technology disclosed in JP 2018-98553A does not conduct verification based on the position of the communication device, and has security concerns.

Accordingly, the present invention is made in view of the aforementioned issue, and an object of the present invention is to control a control target device with improved security.

To solve the above described problem, according to an aspect of the present invention, there is provided a determination device comprising a determination section configured to determine whether a portable device is positioned in a first area or a second area on a basis of results of ranging based on wireless communication between at least two first wireless communication devices and a second wireless communication device in conformity with a designated communication standard, the at least two first wireless communication devices being disposed with a boundary arrangement interposed therebetween, the boundary arrangement being arranged at a boundary between the first area and the second area, the second wireless communication device being installed in the portable device carried by a user, wherein the determination section determines whether the portable device is positioned in the first area or the second area on a basis of a difference between a ranging value calculated by a first wireless communication device disposed in the first area and a ranging value calculated by a first wireless communication device disposed in the second area.

To solve the above described problem, according to another aspect of the present invention, there is provided a determination method comprising causing a processor to determine whether a portable device is positioned in a first area or a second area on a basis of results of ranging based on wireless communication between at least two first wireless communication devices and a second wireless communication device in conformity with a designated communication standard, the at least two first wireless communication devices being disposed with a boundary arrangement interposed therebetween, the boundary arrangement being arranged at a boundary between the first area and the second area, the second wireless communication device being installed in the portable device carried by a user, wherein the determination includes determining whether the portable device is positioned in the first area or the second area on a basis of a difference between a ranging value calculated by a first wireless communication device disposed in the first area and a ranging value calculated by a first wireless communication device disposed in the second area.

To solve the above described problem, according to another aspect of the present invention, there is provided a determination system comprising: at least two first wireless communication devices disposed with a boundary arrangement interposed therebetween, the boundary arrangement being arranged at a boundary between a first area and a second area; a second wireless communication device installed in a portable device carried by a user; and a determination device configured to determine whether the portable device is positioned in the first area or the second area on a basis of results of ranging based on wireless communication between the at least two first wireless communication devices and the second wireless communication device in conformity with a designated communication standard, wherein the determination device determines whether the portable device is positioned in the first area or the second area on a basis of a difference between a ranging value calculated by a first wireless communication device disposed in the first area and a ranging value calculated by a first wireless communication device disposed in the second area.

As described above, according to the present invention, it is possible to control a control target device with improved security.

### BRIEF DESCRIPTION OF THE DRAWINGS

FIG. 1 is a block diagram illustrating a configuration example of a determination system 1 according to an embodiment of the present invention.

FIG. 2 is a diagram for describing an example of disposing first wireless communication devices 110 and a control target device 130 according to the embodiment.

FIG. 3 is a flowchart illustrating a flow of behavior of the determination system 1 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### 1.1. System Configuration Example

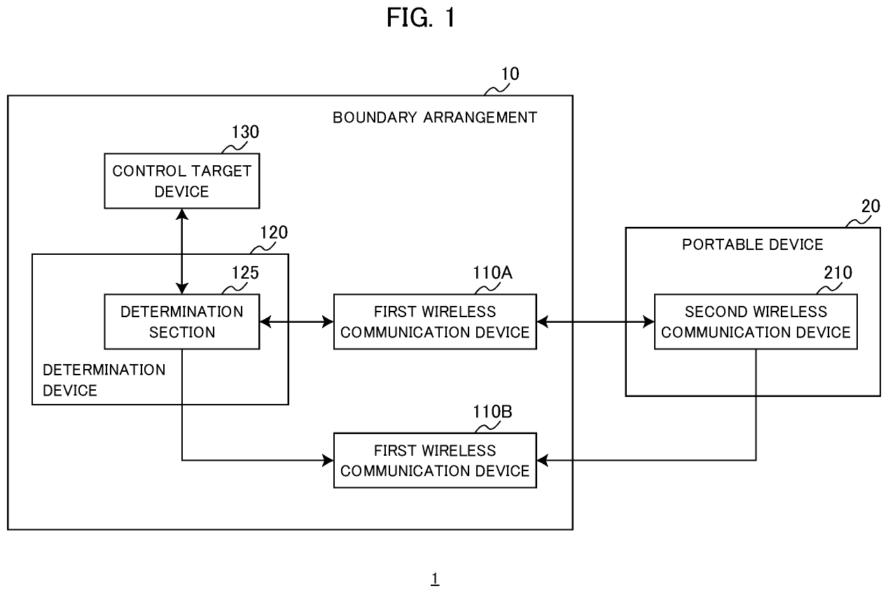

First, a configuration example of a determination system 1 according to an embodiment of the present invention will be described. FIG. 1 is a block diagram illustrating the configuration example of the determination system 1 according to the embodiment of the present invention.

As illustrated in FIG. 1, for example, the determination system 1 according to the present embodiment may include two or more first wireless communication devices 110, a determination device 120, and a control target device 130 that are installed in a boundary arrangement 10.

In addition, as illustrated in FIG. 1, the determination system 1 according to the present embodiment further includes a second wireless communication device 210 installed in a portable device 20 carried by a user.

(Boundary Arrangement 10)

The boundary arrangement 10 according to the present embodiment may be various kinds of objects disposed at a boundary between a first area and a second area. The second area is different from the first area.

For example, the boundary arrangement 10 according to the present embodiment may be a door disposed at a boundary between an inside (an example of the first area) and an outside (an example of the second area) of a room, a gate disposed at a boundary between a private property (an example of the first area) and a public road (an example of the second area), or the like.

(First Wireless Communication Device 110)

The determination system 1 according to the present embodiment includes at least two first wireless communication devices 110.

More specifically, the determination system 1 includes at least one first wireless communication device 110 disposed in the first area and at least one first wireless communication device 110 disposed in the second area.

For example, in the case of the example illustrated in FIG. 1, the determination system 1 includes first wireless communication devices 110A and 110B. In this case, one of the first wireless communication devices 110A and 110B is disposed in the first area, and the other is disposed in the second area.

In addition, for example, the at least two first wireless communication devices 110 according to the present embodiment may be installed on the boundary arrangement 10.

Details of an example of disposing the first wireless communication devices 110 according to the present embodiment will be described later.

Each of the first wireless communication devices 110 according to the present embodiment performs ranging (a process of estimating a distance between the first wireless communication device 110 and the second wireless communication device 210) based on wireless communication with the second wireless communication device 210 in conformity with a designated communication standard. The second wireless communication device 210 is installed in the portable device 20 carried by the user.

Each of the first wireless communication devices 110 according to the present embodiment outputs a ranging value calculated through the ranging (an estimated value of the distance between the first wireless communication device 110 and the second wireless communication device 210) to the determination device 120.

Examples of the designated communication standard according to the present embodiment include ultra-wideband (UWB) wireless communication.

Here, an example of a process related to ranging based on the ultra-wideband (UWB) wireless communication will be described.

For example, each of the first wireless communication devices 110 according to the present embodiment may perform ranging on the basis of a first ranging signal transmitted to the second wireless communication device 210 and a second ranging signal transmitted from the second wireless communication device 210 in response to the first ranging signal.

In this case, it is possible for each of the first wireless communication devices 110 to calculate the ranging value, which is the estimated value of the distance to the second wireless communication device 210, on the basis of a time period ΔT1 and a time period ΔT2. The time period ΔT1 is time from when the first wireless communication device 110 transmits the first ranging signal to when the first wireless communication device 110 receives the second ranging signal. The time period ΔT2 is time from when the second wireless communication device 210 receives the first ranging signal to when the second communication device 210 transmits the second ranging signal.

More specifically, it is possible for each of the first wireless communication devices 110 to calculate time it takes to propagate the first ranging signal and the second ranging signal (that is, time it takes to perform round-trip communication) by subtracting the time period ΔT2 from the time period ΔT1. In addition, it is possible for each of the first wireless communication devices 110 to calculate time it takes to propagate the first ranging signal or the second ranging signal (that is, time it takes to perform one-way communication) by dividing the calculated time by 2.

In addition, by multiplying the value obtained through (time period ΔT1−time period ΔT2)/2 by speed of the signals, it is possible for each of the first wireless communication devices 110 to calculate the ranging value.

Note that, to calculate the ranging value by using the above-described method, it is necessary for each of the first wireless communication devices 110 to recognize the value of the time period ΔT2. Accordingly, the second wireless communication device 210 may transmit information related to the time period ΔT2 to the first wireless communication devices 110.

On the other hand, it is also possible to omit such transmission/reception of the information related to the time period ΔT2, by sharing the time period ΔT2 between the first wireless communication devices 110 and the second wireless communication device 210 as a preset fixed value.

In addition, the first ranging signal according to the present embodiment may be transmitted from the second wireless communication device 210, and the second ranging signal may be transmitted from the first wireless communication devices 110 that have received the first ranging signal.

In this case, it is possible for each of the first wireless communication devices 110 to calculate the ranging value by acquiring information related to the time period ΔT1 from the second wireless communication device 210.

Note that, the above-described calculation of the ranging value using the first ranging signal and the second ranging signal is a mere example. The ranging process according to the present embodiment is not limited thereto.

Each of the first wireless communication devices 110 according to the present embodiment may calculate the ranging value through various kinds of method that are widely used in the field of the ranging technology.

In addition, the designated communication standard according to the present embodiment is not limited to the ultra-wideband wireless communication. Any standards capable of estimating a distance between the first wireless communication devices 110 and the second wireless communication device 210 may be adopted as the designated communication standard according to the present embodiment.

(Determination Device 120)

The determination device 120 according to the present embodiment includes a determination section 125 configured to determine whether the portable device 20 is positioned in the first area or the second area on the basis of respective results of ranging performed by the first wireless communication devices 110.

More specifically, one of features of the determination section 125 according to the present embodiment is to determine whether the portable device 20 is positioned in the first area or the second area on the basis of a difference between a ranging value calculated by a first wireless communication device 110 disposed in the first area and a ranging value calculated by a first wireless communication device 110 disposed in the second area.

Such determination makes it possible to control the control target device 130 with high security on the basis of the area where the portable device 20 is positioned.

Alternatively, the determination section 125 according to the present embodiment may control behavior of the control target device 130 on the basis of a result of such determination.

The functions of the determination section 125 according to the present embodiment are implemented by various kinds of processors. Note that, details of the functions of the determination section 125 according to the present embodiment will be described later.

(Control Target Device 130)

The control target device 130 according to the present embodiment may be various kinds of devices that perform designated behavior under control based on a result of determination made by the determination section 125.

For example, the control target device 130 according to the present embodiment may be a lock device 135 installed in a door 15 that is an example of the boundary arrangement 10.

In this case, the lock device 135 according to the present embodiment may be opened or closed as designated behavior, under control based on the result of determination made by the determination section 125.

For example, the determination section 125 may instruct the lock device 135 to be opened in the case where it is determined that the portable device 20 is positioned outside the room (an example of the second area) and the portable device 20 is positioned within a designated distance from the door 15 on the basis of the ranging values.

In addition, for example, the determination section 125 may instruct the lock device 135 to be closed in the case where it is determined that the position of the portable device 20 has moved from the outside of the room to the inside of the room (an example of the first area).

The highly-accurate area determination according to the present embodiment makes it possible to perform the above-described flexible and precise control depending on the position of the portable device 20.

Note that, the lock device 135 is a mere example of the control target device 130. The control target device 130 according to the present embodiment is not limited thereto.

For example, the control target device 130 according to the present embodiment may be an electric appliance such as lighting equipment, an air conditioner, or the like.

(Portable Device 20)

The portable device 20 according to the present embodiment is a communication device configured to be carried by a user, and includes at least the second wireless communication device 210.

For example, the portable device 20 according to the present embodiment may be a smartphone, a tablet, a wearable device, or the like.

(Second Wireless Communication Device 210)

As described above, the second communication device 210 according to the present embodiment performs wireless communication with the at least two first wireless communication devices 110 in conformity with the designated communication standard.

The configuration example of the determination system 1 according to the present embodiment has been described above. Note that, the configuration described above with reference to FIG. 1 is a mere example. The configuration of the determination system 1 according to the present embodiment is not limited thereto.

The case where the determination section 125 controls the control target device 130 on the basis of the result of determination made by itself has been exemplified above. However, for example, the determination system 1 according to the present embodiment may further include a control device configured to control the control target device 130 on the basis of the result of determination made by the determination section 125.

The configuration of the determination system 1 according to the present embodiment may be flexibly modified in accordance with specifications and operations.

### 1.2. Layout Example

Next, an example of disposing the first wireless communication devices 110 and the control target device 130 according to the present embodiment will be described.

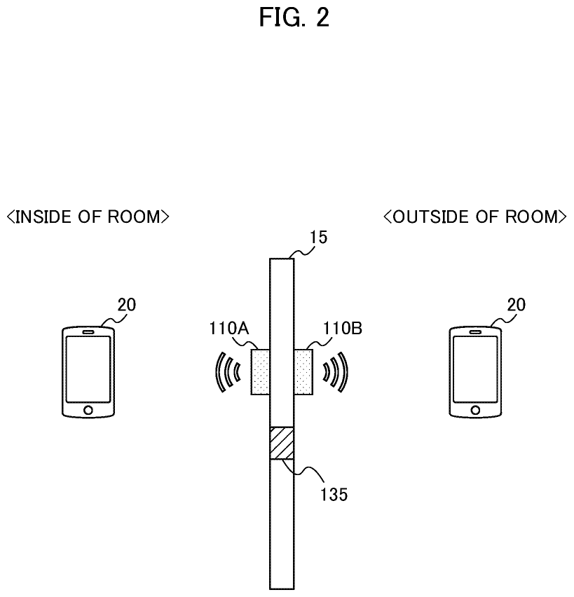

FIG. 2 is a diagram for describing the example of disposing the first wireless communication devices 110 and the control target device 130 according to the present embodiment.

As described above, the boundary arrangement 10 is disposed at a boundary between the first area and the second area according to the present embodiment. In FIG. 2, the inside of the room is an example of the first area, and the outside of the room is an example of the second area. The door 15 is an example of the boundary arrangement 10.

Each of the first area and the second area according to the present embodiment includes at least one of the first wireless communication devices 110.

In the example illustrated in FIG. 2, the first wireless communication device 110A is disposed inside the room, and the first wireless communication device 110B is disposed outside the room.

In addition, the first wireless communication device 110 disposed in the first area and the first wireless communication device 110 disposed in the second area may be installed on the boundary arrangement 10.

In the example illustrated in FIG. 2, the first wireless communication device 110A is installed on an indoor side surface of the door 15, and the first wireless communication device 110B is installed on an outdoor side surface of the door 15.

In addition, as illustrated in FIG. 2, the first wireless communication device 110A is disposed inside the room in such a manner that the first wireless communication device 110A has wireless signal transmission/reception directivity toward the indoor side with reference to the door 15, and the first wireless communication device 110B is disposed outside the room in such a manner that the first wireless communication device 110B has wireless signal transmission/reception directivity toward the outdoor side with reference to the door 15.

Such layout makes it possible to classify an area with high accuracy when determining the area (indoor or outdoor area) by comparing the ranging values. Details thereof will be described later.

Note that, the control target device 130 according to the present embodiment may also be installed in the boundary arrangement 10. Examples of the control target device 130 include the lock device 135 illustrated in FIG. 2.

The example of disposing the first wireless communication devices 110 and the control target device 130 according to the present embodiment has been described above. Note that, the layout described above with reference to FIG. 2 is a mere example. The layout of the first wireless communication devices 110 and the control target device 130 according to the present embodiment is not limited thereto.

For example, the first wireless communication devices 110 according to the present embodiment does not have to be installed on the boundary arrangement 10. In the example illustrated in FIG. 2, the first wireless communication device 110A may be disposed in the back of the room, and the first wireless communication device 110B may be disposed at a position farther from the boundary arrangement 10 in the outside of the room.

Note that, for example, the control target device 130 according to the present embodiment does not have to be installed in the boundary arrangement 10. For example, the control target device 130 according to the present embodiment may be lighting equipment or the like disposed inside the room.

The layout of the first wireless communication devices 110 and the control target device 130 according to the present embodiment may be flexibly modified.

### 1.3. Flow of Behavior

Next, an example of a flow of behavior of the determination system 1 according to the present embodiment will be described in detail.

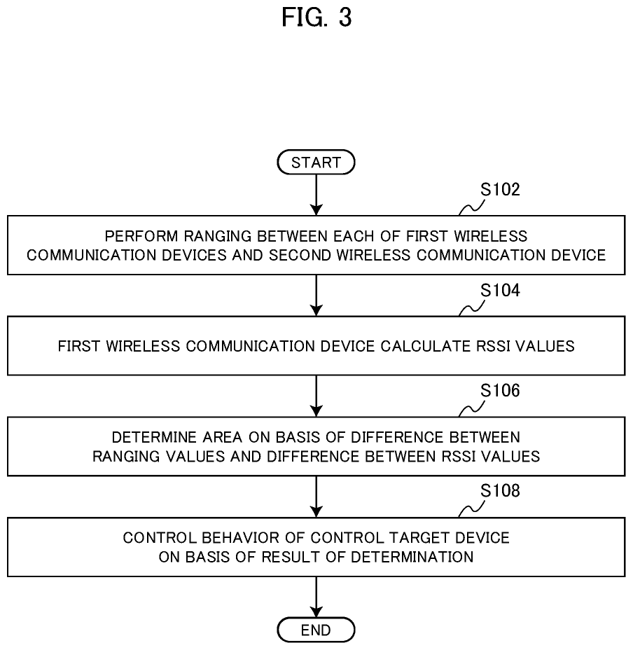

FIG. 3 is a flowchart illustrating the flow of behavior of the determination system 1 according to the present embodiment.

In the example illustrated in FIG. 3, ranging is first performed between each of the first wireless communication devices 110 disposed in the first area and the second area and the second wireless communication device 210 installed in the portable device 20 (Step S102).

Next, each of the first wireless communication devices 110 calculates a received signal strength indicator (RSSI) value of a wireless signal received from the second wireless communication device 210 (Step S104).

Note that, the process in Step S102 and the process in Step S104 may be performed in parallel, or may be performed in reverse order.

Next, the determination section 125 may determine an area (Step S106) on the basis of a difference between the ranging values calculated in Step S102 and a difference between the RSSI values calculated in Step S104.

More specifically, the determination section 125 according to the present embodiment determines whether the portable device 20 is positioned in the first area or the second area on the basis of a difference between a ranging value calculated by a first wireless communication device 110 disposed in the first area and a ranging value calculated by a first wireless communication device 110 disposed in the second area.

In addition, the determination section 125 according to the present embodiment may determine whether the portable device 20 is positioned in the first area or the second area further on the basis of a difference between an RSSI value related to a signal that is received from the second wireless communication device 210 and that is calculated by the first wireless communication device 110 disposed in the first area and an RSSI value related to a signal that is received from the second wireless communication device 210 and that is calculated by the first wireless communication device disposed in the second area.

Here, a detailed example of the determination method according to the present embodiment will be described with reference to the layout example illustrated in FIG. 2.

For example, the determination section 125 may determine that the portable device 20 is positioned inside the room in the case where a determination expression (1) is satisfied.

Determination Expression (1): (ranging value calculated by first wireless communication device 110B disposed outside room)−(ranging value calculated by first wireless communication device 110A disposed inside room)>0

On the other hand, the determination section 125 may determine that the portable device 20 is positioned outside the room in the case where a determination expression (2) is satisfied.

Determination Expression (2): (ranging value calculated by first wireless communication device 110B disposed outside room)−(ranging value calculated by first wireless communication device 110A disposed inside room)<0

As described above, the determination section 125 according to the present embodiment is capable of making the highly-accurate area determination by comparing a ranging value calculated by a first wireless communication device 110 disposed in the first area with a ranging value calculated by a first wireless communication device 110 disposed in the second area.

However, it is also considered that sometimes it is difficult to make a difference between the two ranging values depending on the thickness and material of the door 15.

Therefore, the determination section 125 may determine that the portable device 20 is positioned inside the room in the case where the determination expression (1) and a determination expression (3) are satisfied.

Determination Expression (3): (RSSI value calculated by first wireless communication device 110B disposed outside room)−(RSSI value calculated by first wireless communication device 110A disposed inside room)<0

In addition, the determination section 125 may determine that the portable device 20 is positioned outside the room in the case where the determination expression (2) and a determination expression (4) are satisfied.

Determination Expression (4): (RSSI value calculated by first wireless communication device 110B disposed outside room)−(RSSI value calculated by first wireless communication device 110A disposed inside room)>0

Such area determination based on the difference between the ranging values and the difference between the RSSI values makes it possible to classify the area where the portable device 20 is positioned with high accuracy.

After the area determination in Step S106, the determination section 125 controls behavior of the control target device 130 on the basis of a result of the determination (Step S108).

The determination section 125 may control the behavior of the control target device 130 on the basis of a single determination result. Alternatively, the determination section 125 may make a determination multiple times and control the behavior of the control target device 130 on the basis of change in the determination result.

The example of the flow of the behavior of the determination system 1 according to the present embodiment has been described above. Note that, the flow of behavior illustrated in FIG. 3 is a mere example. The flow of behavior of the determination system 1 according to the present embodiment is not limited thereto.

For example, in the case where any of the first wireless communication device 110 disposed in the first area and the first wireless communication device 110 disposed in the second area has failed to calculate the ranging value or the RSSI value, the determination section 125 may determine that the portable device 20 is positioned in an area different from the areas where the first wireless communication device 110 has failed to calculate the ranging value or the RSSI value.

Alternatively, for example, the determination section 125 may perform control in such a manner that the ranging values and the RSSI values are calculated again in the case where a determination result based on the ranging values is contradictory to a determination result based on the RSSI values.

The flow of the behavior of the determination system 1 according to the present embodiment can be flexibly modified.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

In addition, the series of processes performed by each of the devices described herein may be achieved by a program stored in a non-transitory computer readable storage medium. For example, each program is loaded into RAM, and executed by a processor such as a CPU when a computer executes each of the program. The storage medium may be a magnetic disk, an optical disc, a magneto-optical disc, flash memory, or the like, for example. Alternatively, the above-described programs may be distributed via a network without using the storage medium, for example.

What is claimed is:

1. A determination device comprising
a determination section configured to determine whether a portable device is positioned in a first area or a second area on a basis of results of ranging based on wireless communication between at least two first wireless communication devices and a second wireless communication device in conformity with a designated communication standard, the at least two first wireless communication devices being disposed with a boundary arrangement interposed therebetween, the boundary arrangement being arranged at a boundary between the first area and the second area, the second wireless communication device being installed in the portable device carried by a user,
wherein the determination section determines whether the portable device is positioned in the first area or the second area on a basis of a difference between a ranging value calculated by a first wireless communication device disposed in the first area and a ranging value calculated by a first wireless communication device disposed in the second area.

2. The determination device according to claim 1,
wherein the determination section determines whether the portable device is positioned in the first area or the second area further on a basis of a difference between an RSSI value related to a signal that is received from the second wireless communication device and that is calculated by the first wireless communication device disposed in the first area and an RSSI value related to a signal that is received from the second wireless communication device and that is calculated by the first wireless communication device disposed in the second area.

3. The determination device according to claim 2, wherein
the first wireless communication device is disposed in the first area in such a manner that the first wireless communication device has directivity toward the first area side with reference to the boundary arrangement, and
the first wireless communication device is disposed in the second area in such a manner that the first wireless communication device has directivity toward the second area side with reference to the boundary arrangement.

4. The determination device according to claim 3,
wherein the first wireless communication device disposed in the first area and the first wireless communication device disposed in the second area are installed on the boundary arrangement.

5. The determination device according to claim 1,
wherein the determination section controls behavior of a control target device on a basis of the determined position of the portable device.

6. The determination device according to claim 5,
wherein the control target device includes a lock device installed in the boundary arrangement.

7. The determination device according to claim 5,
wherein the boundary arrangement includes a door.

8. The determination device according to claim 5,
wherein the designated communication standard includes ultra-wideband wireless communication.

9. A determination method comprising
causing a processor to determine whether a portable device is positioned in a first area or a second area on a basis of results of ranging based on wireless communication between at least two first wireless communication devices and a second wireless communication device in conformity with a designated communication standard, the at least two first wireless communication devices being disposed with a boundary arrangement interposed therebetween, the boundary arrangement being arranged at a boundary between the first area and the second area, the second wireless communication device being installed in the portable device carried by a user,
wherein the determination includes determining whether the portable device is positioned in the first area or the second area on a basis of a difference between a ranging value calculated by a first wireless communication device disposed in the first area and a ranging value calculated by a first wireless communication device disposed in the second area.

10. A determination system comprising:
at least two first wireless communication devices disposed with a boundary arrangement interposed therebetween, the boundary arrangement being arranged at a boundary between a first area and a second area;
a second wireless communication device installed in a portable device carried by a user; and
a determination device configured to determine whether the portable device is positioned in the first area or the second area on a basis of results of ranging based on wireless communication between the at least two first wireless communication devices and the second wireless communication device in conformity with a designated communication standard,
wherein the determination device determines whether the portable device is positioned in the first area or the second area on a basis of a difference between a ranging value calculated by a first wireless communication device disposed in the first area and a ranging value calculated by a first wireless communication device disposed in the second area.
